(19) United States
(12) Patent Application Publication
(10) Pub. No.: US 2018/0038525 A1
(43) Pub. Date: Feb. 8, 2018

(54) CONNECTING ARRANGEMENT FOR PIPES

(71) Applicant: Benteler Automobiltechnik GmbH, Paderborn (DE)

(72) Inventors: Thorsten KWAST, Herford (DE); Markus MEHRING, Lichtenau (DE)

(21) Appl. No.: 15/552,411

(22) PCT Filed: Feb. 26, 2016
(86) PCT No.: PCT/DE2016/100087

§ 371 Date: Aug. 21, 2017

(30) Foreign Application Priority Data
Feb. 27, 2015 (DE) 10 2015 102 877.8

(51) Int. Cl. F16L 19/02; F02M 55/00

(52) U.S. Cl. CPC F16L 19/0206; F02M 55/005; F16L 2201/30; F16L 2201/10

(57) ABSTRACT

A connecting arrangement for connecting a pipeline to a connection piece of fuel or hydraulic systems is disclosed having a connecting element in the form of a union nut. A sealing head includes a sealing surface and a pressure surface and is provided at the end side of the pipeline. The union nut serves to press the sealing head by the sealing surface in a pressure-tight manner against a sealing seat formed in the connection piece. Leakage paths are provided at the rear side of the sealing head outside the sealing surface and the sealing seat. The leakage paths function as predetermined leakages and ensure that sealing outside the actual sealing region of the connecting arrangement is prevented.

### CROSS REFERENCE TO RELATED APPLICATIONS

The present application is a National Phase of International Application Number PCT/DE2016/100087 filed Feb. 26, 2016, and claims priority benefits from German Application Number 10 2015 102 877.8 filed Feb. 27, 2015.

### BACKGROUND

### 1. Field of the Invention

The disclosure is related to a connecting arrangement for connecting a pipeline to a connection piece of fuel or hydraulic systems, and more specifically to a connecting arrangement for connecting a pipeline to a connection piece in fuel distribution systems.

### 2. Description of the Related Art

Connecting arrangements are used in fuel distribution systems of internal combustion engines. In fuel distribution systems, the pressure production and the fuel injection are decoupled from each other. A fuel pump continuously produces pressure. This pressure which is built up independently of the injection sequence is permanently available in the fuel distributor which functions as a pressure store. To this end, the compressed fuel is made available to the injectors or injection valves of a cylinder bank in a state stored in a distributor pipe and distributed via branch lines.

A known connecting arrangement is described in DE 196 07 521 C1. A number of threaded bushes are welded or soldered to a distributor pipe. The threaded bushes have continuous inner holes which continue branch holes in the wall of the distributor pipe. At the end side of each pipeline, there is provided a sealing head which by means of a union nut which is screwed onto the threaded bush is pressed with the sealing face thereof against a sealing seat in the threaded bush and tensioned in a pressure-tight manner.

A comparable configuration is shown by the pressure line connection according to DE 44 07 306 C1. DE 10 2005 045 731 B4 and DE 10 2005 003 519 A1 also disclose common and practical connecting arrangements for pipes.

The sealing heads are, under the influence of the connection elements which act at least indirectly on the pressure face, moved with the sealing face into abutment in a pressure-tight manner against a sealing seat which is constructed in the connection piece. Generally, the connection element is a union nut. The hydraulic sealing is carried out by pressing the sealing head with the sealing face thereof against the sealing seat which is constructed in the connection piece. The sealing action is produced as a result of the pressing force between the metal sealing elements. The pressing force is applied by the connection means.

A problem in the connecting arrangements is an operationally reliable sealing during assembly. In practice, the connection element and the connection piece are joined together with the pipeline being introduced with the sealing head via a screw connection. In this instance, the screw connection is tightened at least to such an extent that, over the entire sealing periphery between the sealing face and sealing seat, a surface pressure which ensures the required tightness is achieved. Generally, an examination of the tightness of the connecting arrangement is required. This is particularly the case in fuel or hydraulic systems for high-pressure applications.

In this context, systems with permanent leakage monitoring or examination of the sealing state are known. DE 10 2008 006 196 A1 provides for this purpose a separate leakage line and a leakage detection screw which cooperates with the high-pressure fuel line. DE 601 17 927 T2 also describes an arrangement for locating a fuel leak in connection with a large internal combustion engine.

DE 10 2008 041 537 A1 discloses a method for testing the sealing state of a fuel injector, in particular in an internal combustion engine.

Separate holes for leakage lines and/or leakage detection screws are, however, mechanically complex and under some circumstances susceptible to malfunction.

In addition to permanent leakage monitoring, which is advantageous with large engines which are in particular in permanent use, there are known in particular in the automotive industry leakage search methods for integral sealing testing and leakage location during production. In addition to sealing tests using air via pressure drop or in a water bath, test methods using inert gas, so-called sniff tests, have become established. In this instance, helium is used in particular as a test gas. Sniff tests enable selective location of leakages with the highest level of sensitivity.

In practice, in particular in the automotive industry, as a result of the small cycle time in the production for the sealing test, only a limited period of time is available. Consequently, a rapid and efficient sealing test is generally desirable. In this instance, the fact may be problematic that, as a result of the tightening of the connection element with respect to the connection piece, a sealing in the connecting arrangement may occur, but with this sealing being located outside the actual sealing region between the sealing face and sealing seat. In particular, the connection element may press so powerfully against the rear region of the sealing head that there is produced at that location a sealing which is, however, generally not permanent and operationally reliable. Nonetheless, this undesirable or locally displaced sealing prevents leakage location during the sealing test.

### SUMMARY

According to one exemplary embodiment, there is a pipeline which is connected to a connection piece within a fuel or hydraulic system, in particular a fuel distribution system. The pipeline is connected to the connection piece by means of a connection element. At the end side of the pipeline a sealing head is provided. It may be a materially uniformly integral component at the end of the pipeline or may be joined to the end of the pipeline as a separately produced component by means of a thermal joining method. The sealing head has a sealing face and a pressure face which is provided at the rear side of the sealing head. The sealing head is, under the influence of the connection element which acts at least indirectly on the pressure face, pressed with the sealing face in a pressure-tight manner onto a sealing seat which is formed in the connection piece.

The connecting arrangement further includes one or more leakage paths which are provided in the region outside the sealing face and the sealing seat. The one or more leakage paths act as predetermined leakages and keep the connecting arrangement free-moving at the rear side of the sealing region, that is to say, outside the sealing seat and the sealing face. A reliable discharge of test gas during the sealing test and leakage location by means of sniff tests is thereby ensured. In this manner, it is ensured that a reliable identification and statement relating to the sealing of the system can be made in a comparatively short detection time. In a state integrated in the production process, production and/or assembly errors can thereby be identified in a timely and reliable manner.

It is inventively significant that the one or more leakage paths, in spite of the metal surface pressure in the tightened state of the connecting arrangement at the rear side of the sealing head, enable the discharge of test gas. The basic notion according to the invention ensures a predetermined leakage and significantly shortens the hydraulic pressure test time within the test, in particular of an engine test with the so-called sniff method or test.

The function in the sealing region between the sealing face of the pressure head and sealing seat in the connection piece is not impaired by the leakage paths. An angle compensation between the axis of the sealing head or the pipeline and the axis of the connection piece is also possible so that the sealing head can be orientated relative to the sealing seat. As a result of such an angle compensation, a forced position of the pipeline and consequently tensions in the pipeline can be reduced.

According to one exemplary embodiment, the one or more leakage paths may be formed by a recess in the connection element in each case. The connection element is preferably a union nut. The union nut has a threaded portion with an inner thread. The union nut cooperates with an outer thread on the connection piece. In particular a threaded connection piece or a threaded bush is provided on the connection piece. Furthermore, the union nut has an internal, in particular obliquely extending, pressure shoulder which is in abutment with the pressure face of the sealing head. For connection, the union nut is screwed to the threaded portion of the connection piece and tightened to such an extent that over the entire periphery of the seal a surface pressure which ensures the required tightness is achieved. The one or more leakage paths may be constructed in the pressure shoulder.

A connection element in the form of a union nut is particularly advantageous and field-tested. In principle, however, the connection element may also be a differently constructed screw connection element, for example, a screw plug with an outer thread.

According to another exemplary embodiment, the one or more leakage paths may be formed by a recess in the pressure face of the sealing head. The leakage paths are consequently provided at the rear side of the sealing head at the side of the sealing head opposite the sealing face.

According to another exemplary embodiment, a plurality of leakage paths which are arranged offset with respect to each other on a pitch circle are provided.

The leakage paths to be formed by recesses such as, notches, grooves or similar cut-out portions may be involved. The production of the recesses can be carried out in a rational manner in terms of technical production. For example, recesses in the form of notches or grooves can be produced in a technical stamping manner with material displacement and in a material-removing manner or milling manner. The recesses are formed in or on the connection element, in particular in the pressure shoulder of a union nut. Furthermore, the recesses may be provided on or in the pressure face of the sealing head. Leakage paths may also be provided both on the connection element and on the sealing head, in a region outside the sealing face and the sealing seat of the connecting arrangement.

The leakage paths to be orientated in the longitudinal direction of the pipeline. The leakage paths extend in the axial direction of the connecting arrangement. This measure contributes to a high degree of ability to qualify leakages during the tightness test and leakage location of a connecting arrangement.

The connecting arrangement according to one exemplary embodiment ensures with the selective arrangement of leakage paths outside the sealing region that even the smallest limit leakage rates can be detected. In this manner, a leakage location within the fuel or hydraulic system, in particular on fuel distributors of fuel injection systems, is possible with short cycle and detection times and a high level of test precision. Accordingly, during the sealing test and leakage location, not only pores or cracks, that is to say, material defects, can be detected in structural components, but also occurrences of processing or assembly imprecision of components of the connecting arrangement.

### BRIEF DESCRIPTION OF THE DRAWINGS

For an understanding of embodiments of the disclosure, reference is now made to the following description taken in conjunction with the accompanying drawings, in which:

FIG. 1 is a side view of a connecting arrangement according to the invention;

FIG. 2 is a section through the connecting arrangement according to the illustration of FIG. 1 along line D-D;

FIG. 3 is an enlarged illustration of the cut-out E of FIG. 2;

FIGS. 4a and 4b are two different perspective views of a connection element in the form of a union nut;

FIG. 5a is a front view of a union nut;

FIG. 5b is a longitudinal section through the illustration of FIG. 5a) along the line A-A;

FIGS. 6a to 6c are a perspective view, front view and longitudinal section of a sealing head;

FIGS. 7a to 7c are a perspective view, front view and longitudinal section of another embodiment of a sealing head; and,

FIGS. 8a to 8c are a perspective view, front view and longitudinal section of the end portion of a pipeline with a sealing head.

In the Figures, the same reference designations are used for identical or similar components, even if a repeated description is omitted for reasons of simplicity.

### DETAILED DESCRIPTION OF SOME EMBODIMENTS

Some embodiments will be now described with reference to the Figures.

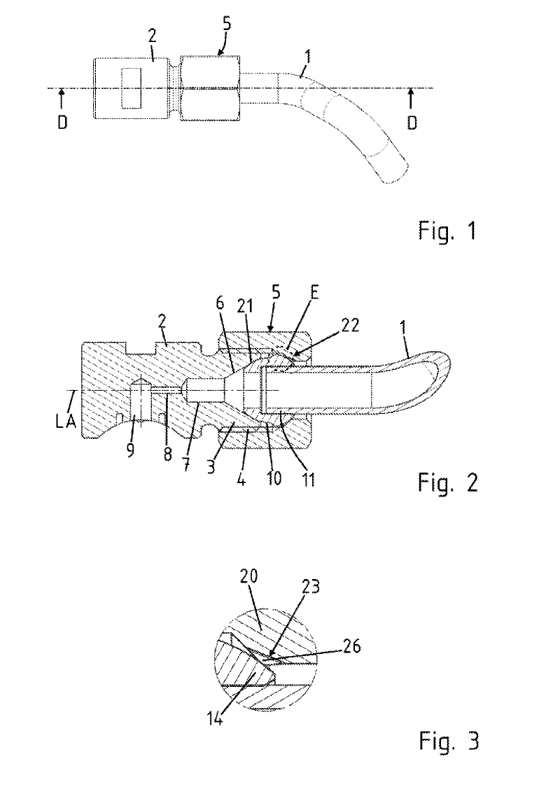

FIGS. 1 and 2 present an exemplary embodiment for a connecting arrangement for connecting a pipeline 1 to a connection piece 2. The connecting arrangement is an integral component of a fuel or hydraulic system. The pipeline 1 and the connection piece 2 are integral components of a fuel distribution system, for example, a common rail system for petroleum or diesel engines. The connection piece 2 is joined to a distributor pipe (not illustrated in this instance) of the fuel distribution system. The components of the connecting arrangement comprise metal.

For connecting the pipeline 1 to the connection piece 2, the connection piece 2 has a threaded connection piece 3 with an outer thread 4. The connection of the pipeline 1 to the connection piece 2 is carried out via a connection element 5 in the form of a union nut which is screwed to the threaded connection piece 3.

A sealing cone 6 is formed at the input side of the threaded connection piece 3, which is continued by an inner hole 7. The inner hole 7 is adjoined by a connection hole 8 which has a smaller diameter than the diameter of the inner hole 7 and which strikes a connection hole 9 in the connection piece 2. The connection hole 9 is orientated transversely with respect to the connection hole 8.

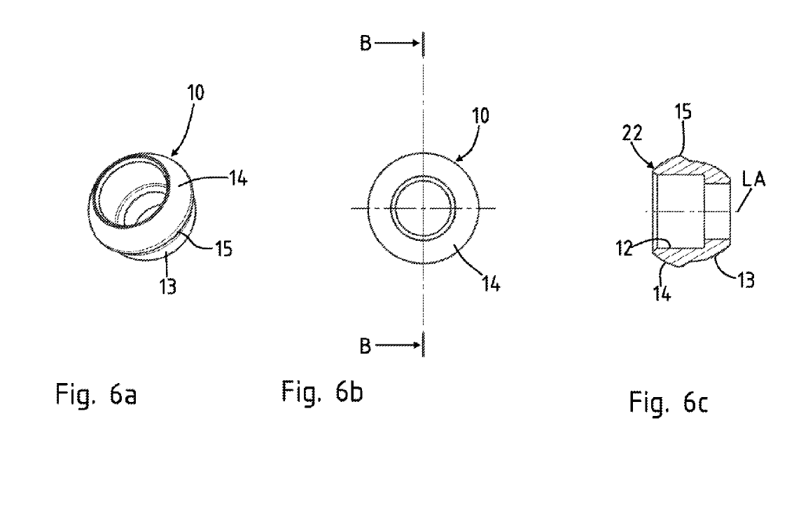

Referring to FIGS. 6a and 6b, a sealing head 10 is provided at the end of the pipeline 1. The sealing head 10 is a separate component of metal which is placed on the end 11 of the pipeline 1 and which is thermally joined to the pipeline 1, in particular by means of hard soldering or welding. In order to receive the end 11 of the pipeline 1, an adapter portion 12 is provided in the sealing head 10. The sealing head 10 has a front sealing face 13 which is in particular configured in the form of a sphere portion or freely and a rear-side pressure face 14. The sealing face 13 merges via a rounded shoulder crown 15 into the rear-side pressure face 14.

The union nut is guided with an opening 16 in the base 17 thereof over the pipeline 1. In order to connect the pipeline 1 to the connection piece 2, the union nut is screwed onto the outer thread 4 of the threaded connection piece 3. The union nut has a sleeve portion 18 with an inner thread 19 by means of which it can be screwed onto the outer thread 4 of the threaded connection piece 3. At the inner side of the base 17 of the union nut, there is formed an inclined pressure shoulder 20 which, when the union nut is screwed on, moves into abutment with the pressure face 14 of the sealing head 10. It can be seen that the pressure shoulder 20 expands from the opening 16 in the base 17 in the direction toward the sleeve portion 18.

When the screw connection is produced between the union nut and threaded connection 3, the pressure shoulder 20 presses on the pressure face 14, whereby the sealing head 10 is pressed with the front sealing face 13 thereof against or into the sealing cone 6. In this instance, the sealing cone 6 forms a sealing seat 21, against which the sealing head 10 moves with the sealing face 13 thereof into abutment in a tensioned and pressure-tight state.

The connection between the pipeline 1 with the end-side sealing head 10 thereof and the connection piece 2 via the union nut is permanent and robust. Any assembly tolerances or warping in the components of the connecting arrangement or downstream or upstream structural components can be compensated for by the connecting arrangement. The sealing action is ensured in the sealing region by the cooperation or pressing-together of the sealing face 13 of the sealing head 10 on the sealing seat 21 of the connection piece 2.

After assembly, the connecting arrangement is subjected to a sealing test and leakage location by means of a sniff test. During this sealing test, the connecting arrangement or the fuel system to which the connecting arrangement belongs is acted on with a test gas. Any leakages are identified by means of sniff sensors.

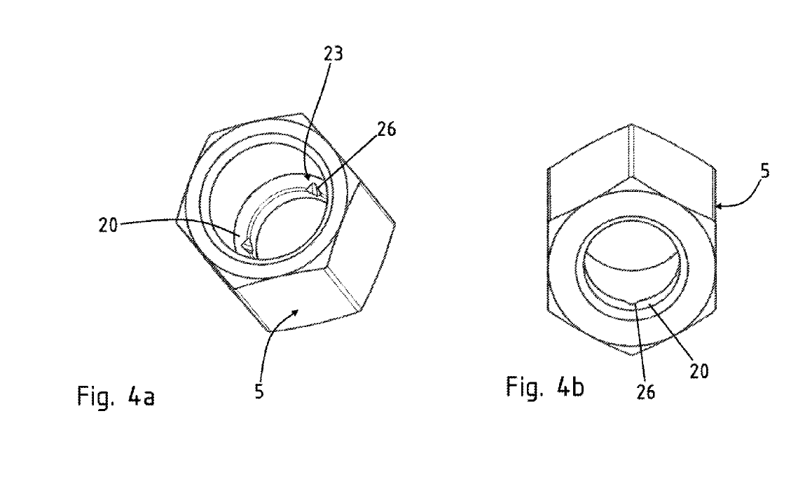

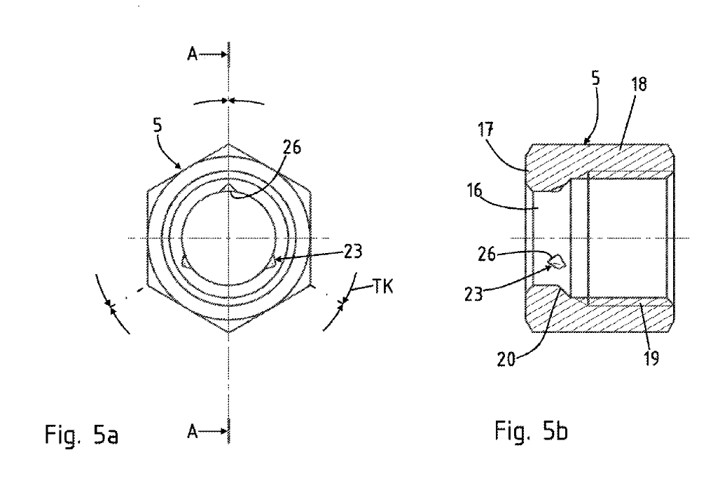

At the rear side 22 of the sealing head 10 in the region outside the sealing face 13 and the sealing seat 21, leakage paths 23 are provided. The leakage paths 23 are in the embodiment according to FIGS. 2 to 5 constructed on or in the union nut. As can be seen in particular in FIGS. 3, 4 and 5, the leakage paths 23 are constructed in the pressure shoulder 20 and extend in the direction of the longitudinal axis LA of the connecting arrangement or the pipeline 1.

It can be seen that a plurality of leakage paths 23, that is to say, three leakage paths 23, are arranged on a pitch circle TK in a state offset at an angle of 120° with respect to each other.

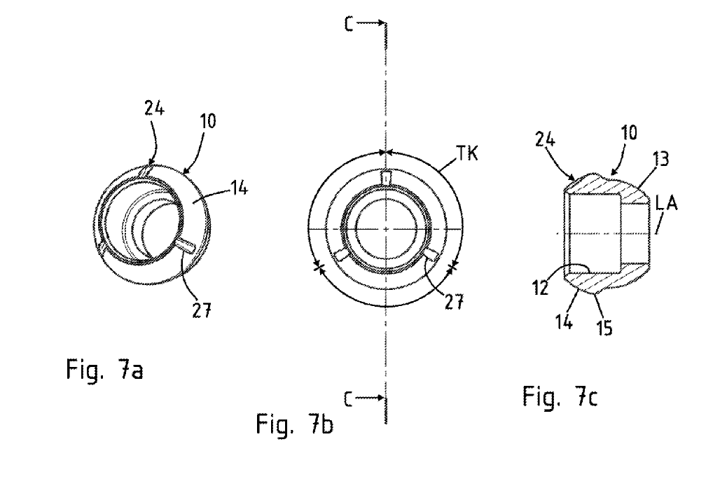

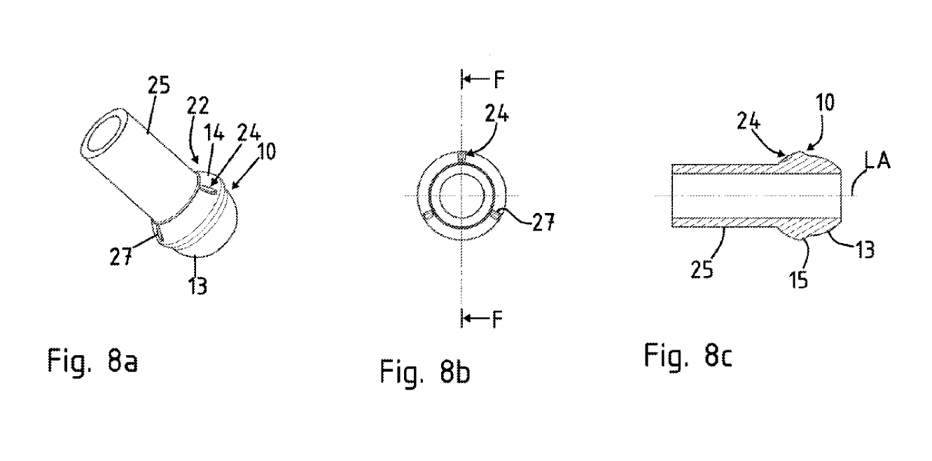

Referring to FIGS. 7a-7c and 8a-8c, a sealing head 10 is illustrated, in which the leakage paths 24 are constructed in each case at the rear side 22 of the sealing head 10 in the region of the pressure face 14 of the sealing head 10.

FIGS. 7a to 7c illustrate a sealing head 10 which is placed on the end 11 of a pipeline 1 and which is joined to the pipeline 1 by means of a thermal joining method.

The sealing head 10 illustrated in FIGS. 8a to 8c has a connection portion 25 for connecting to a pipeline 1. In principle, the sealing head 10 may also be formed at the end side materially uniformly and integrally at the end 11 of a pipeline 1 by means of a compression operation.

The sealing head 10 according to the embodiment of FIGS. 8a to 8c also has leakage paths 24 at the rear side 22 of the sealing head 10.

Still with reference to FIGS. 7a-7c and 8a-8c, three leakage paths 24 are provided on the periphery of the pressure face 14 and are arranged on a pitch circle TK in a state offset at an angle of 120° with respect to each other.

The leakage paths 23, 24 are constructed by means of recesses 26, 27 in the form of grooves or notches. They may be stamped in the pressure face 14 or the pressing shoulder 20 or introduced by means of a material-removal method.

As illustrated in FIGS. 3, 7a-7c, and 8a-8c, the leakage paths 23 or 24 extend in the direction of the longitudinal axis LA of the pipeline 1.

The leakage paths 23, 24 which are provided according to the invention at the rear side 22 of the sealing head 10 outside the sealing region between the sealing face 13 and sealing seat 21 ensure a reliable detection of occurrences of non-fluid-tightness or leakages during a sealing test and leakage location using sniff tests. If an occurrence of non-fluid-tightness should be present between the sealing face 13 and sealing seat 21, test gas flows over and can pass the rear region of the connecting arrangement at the rear side 22 of the sealing head 10 through the leakage paths 23, 24 so that the test gas can be reliably detected outside the connecting arrangement by means of sensors.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A connecting arrangement for connecting a pipeline having an end to a connection piece of fuel or hydraulic systems, comprising:
a connection element for connecting the pipeline to the connection piece,
a sealing head disposed at the pipeline end, the sealing head having a sealing face and a pressure face, the sealing head under the influence of the connection element which acts at least indirectly on the pressure face abuts the sealing face in a pressure-tight manner with a sealing seat formed in the connection piece, and
wherein at least one leakage path is provided in a region outside the sealing face and the sealing seat.

2. The connecting arrangement as claimed in claim 1, wherein the at least one leakage path is formed by a recess in the connection element.

3. The connecting arrangement as claimed in claim 1, wherein the at least one leakage path is formed by a recess in the pressure face of the sealing head.

4. The connecting arrangement as claimed in claim 1, wherein the connection element is a union nut.

5. The connecting arrangement as claimed in claim 4, wherein the union nut has an internal pressure shoulder which extends in an inclined manner and abuts the pressure face of the sealing head, wherein the leakage path is formed in the pressure shoulder.

6. The connecting arrangement as claimed in claim 1, wherein the at least one leakage path comprises a plurality of leakage paths arranged offset with respect to each other on a pitch circle.

7. The connecting arrangement as claimed in claim 1, wherein the at least one leakage path extends in the direction of the longitudinal axis of the pipeline.

8. The connecting arrangement as claimed in claim 1, wherein the sealing seat is formed in a sealing cone of the connection piece.

9. The connecting arrangement as claimed in claim 1, wherein the leakage paths act as predetermined leakages and keep the connecting arrangement free-moving at the rear side of the sealing region outside the sealing seat and the sealing face, wherein the discharge of test gas is ensured during the sealing test.
